(19) United States
(12) Patent Application Publication
(10) Pub. No.: US 2001/0011954 A1
(43) Pub. Date: Aug. 9, 2001

(54) PUBLIC AREA LOCATOR SYSTEM

(76) Inventors: MONTY M. SHELTON, CARROLLTON, TX (US); KEVIN ANDERSON, PLANO, TX (US)

Correspondence Address: MONTY M SHELTON, 1712 SOUTHAMPTON, CARROLLTON, TX, 75007, US

(21) Appl. No.: 09/038,518

(22) Filed: Mar. 11, 1998

(51) Int. Cl. H04Q 1/00; H04B 1/00

(52) U.S. Cl. 340/825.49; 340/5.64

(57) ABSTRACT

A wireless personnel locator system includes a plurality of low power, compact, radio frequency (RF) transmitters adapted to continuously transmit narrow band modulated or spread spectrum modulated signals, including a transmitter identification code or serial number. Designated public areas such as retail merchant complexes, exhibit halls, and entertainment complexes have identified RF receivers at designated locations, such as entrance and exit portals, for receiving transmitter signals and transmitting related information to a control center processing unit which correlates the received signals with a subscriber or authorized person for each of the transmitters. The transmitters may be incorporated in easily carried devices such as key chain fobs, integrated into pager devices or cellular phones or encapsulated in an elastic band worn by the user. The processing unit may be in communication with a security department for providing information regarding the whereabouts of persons about to make unauthorized exits from or entrances into particular areas. A communication unit may be available to subscribers at particular locations in the designated areas for accessing information as to the whereabouts of a person carrying a transmitter.

### FIELD OF THE INVENTION

The present invention pertains to a wireless personnel or article locator system including compact, portable radio frequency transmitters carried by persons or attached to movable articles, multiple stationary radio frequency receivers and a control system including one or more electronic digital central processing units connected to the receivers for identifying signals transmitted by the transmitters and to identify the location of the person or article which is carrying a particular transmitter.

### BACKGROUND OF THE INVENTION

There are many instances in which the whereabouts of a person or persons (or the location of a moveable article) is desired to be known to others, particularly in a public area. When a group of persons, including parents and children, for example, are moving about in a generally public area, such as a retail merchant shopping complex or “mall”, a public or private trade exhibit area, or a sports or amusement complex, certain persons may move away from the group or a person responsible for the others and become lost, or there exists a need for the parent or the responsible person to monitor the whereabouts of such other persons. Moreover, it is desirable that a person moving unescorted in public areas, such as those mentioned above, be secure or have a sense of security by being able to signal an authority that the unescorted person is lost, has suffered an injury or sudden illness or believes oneself to be in jeopardy.

Accordingly, with the foregoing in mind, it is desirable to be able to provide persons moving about in public areas with inexpensive and unobtrusive devices which are part of a system capable of signaling their whereabouts for the purposes indicated above, as well as for other purposes wherein the approximate location or whereabouts of a person (or a moveable article) is desired to be known. Such a system should be capable of including low power signaling devices, such as radio frequency (RF) transmitters which are constantly sending a signal to one or more RF receivers which, in turn, are capable of identifying the signaling device or transmitting the signal information to a control center including a central processing unit. The control center should then be capable of identifying the transmitter location and provide such information to other locations, such as a security or police department in proximity to or at the facility from which the signals are being received. It is also desirable that such a system be capable of providing such information to subscribers to the system at one or more locations within the facility in which the monitoring is taking place.

In view of the widespread use of location transmitters in a system contemplated above, it is important that the transmitter devices be capable of low power, long term use and transmission of signals which will not interfere with a large number of signals coming from other transmitter devices within the same facility or area. It is also important that the information being furnished by the transmitters be concise, yet complete, in order to minimize electrical power requirements and thereby extend the useful operating life of the transmitter devices while providing sufficient information to enable security personnel and others to monitor the whereabouts of the transmitter devices. In this regard also it is contemplated that it is important to provide a system which has a large number of receivers for receiving the signals transmitted by each transmitter being carried about a facility so that a transmitter is within range of transmitting signals at all times to two or even three receivers. In this way receiver coverage within the facility providing the locator or security service is such that at least two and preferably three receivers are always receiving a signal from a working transmitter in the facility.

The problems associated with providing a suitable locator system having the requisite features set forth above, for example, have been solved by the present invention.

### SUMMARY OF THE INVENTION

The present invention provides a wireless locator system, particularly adapted for monitoring the location of persons in a public area, such as a retail merchant shopping complex, exhibit or entertainment complex or the like and operable to provide location information to those having a need to know the whereabouts of such persons.

In accordance with one aspect of the present invention a locator system is provided which includes a plurality of subscriber carried RF transmitters which are adapted to provide a radio frequency signal on a substantially continuous basis identifying the transmitter and thus the person carrying same. The signals generated by the transmitters are received by stationary RF receivers located in known positions and which will, upon identifying a signal from each of the transmitter devices, relay or re-transmit the signal to a control center including a computer or central processing unit for identifying a type of message being transmitted, measure the signal strength and determine a relatively precise location of the transmitter. Transmitter location determination may be based on a bearing or angle of arrival or time of arrival of a signal or signals being transmitted to multiple receivers.

In accordance with another aspect of the invention a locator system is provided wherein a substantial number of RF receivers are deployed at a particular facility in a predetermined grid pattern within the facility or at specific locations within the facility which will enable the system to continuously monitor the location or a particular transmitter within that facility at all times. In one embodiment of the system each receiver may be hard wired to a control center and a central processing unit. In another embodiment of the system each RF receiver includes its own transmitter which may, by infrared (IR) or RF transmission, transmit the identified transmitter signal to a repeater unit comprising a receiver and transmitter which may, by IR or RF transmission, or by hard wire communication methods communicate the signal information to the control center.

In accordance with still another aspect of a system in accordance with the present invention, an additional information processing unit may be provided which includes a database that identifies the subscriber person or persons carrying the transmitter or whose identity has been assigned to the transmitter in question. This information may be transmitted to terminals or data processor devices via the control center and which are located in security departments for the facility in which the system is operating. Such information may also be made available at one or more terminals which include visual displays which may be accessed by a subscriber or a person having a suitable authorization code so that, for example, a parent in a retail shopping complex or mall may access the nearest visual display to determine the whereabouts of a child carrying a transmitter within the facility.

The present invention further provides a location determining system of the type described hereinabove which includes a device incorporating an RF transmitter which may be easily carried by a person. In one embodiment of the device, the transmitter is incorporated into a fob or the like which may be attached to a key ring or other personal article normally carried by a person using the transmitter. Alternatively, the transmitter may be encapsulated in a flexible wrist or leg band, for example, which may be easily worn, inconspicuously, by the person whose whereabouts is to be monitored. The device may include user actuatable switches which cause the transmitter to send certain communication or emergency signals to the control center and to a security department. The transmitter may also be included in a RF pager or other telephony device, such as a so-called cellular telephone.

In accordance with yet a further aspect of the present invention, a personnel or article locator system is provided wherein a device includes an RF transmitter carried by a person or placed on an article whose whereabouts is to be determined which operates at low effective radiated power, operates below radiation hazard levels at all times, is substantially continuously transmitting a signal, may include a paging signal generator and a page response signal means and may provide radio frequency message modulation of either narrow band or spread spectrum character. The operating frequency may be within a licensed or unlicensed spectrum.

Those skilled in the art will further appreciate various aspects of the location system of the present invention upon reading the detailed description which follows in conjunction with the drawings.

### BRIEF DESCRIPTION OF THE DRAWINGS

FIG. 1 is schematic diagram of a personnel or moveable article location system of the present invention;

FIG. 2 is a plan view of one embodiment of a portable device including a radio frequency transmitter for use with the system of the present invention;

FIG. 3 is a perspective view of another embodiment of a device which includes a radio frequency transmitter for use with the system of the invention;

FIG. 4 is a schematic diagram of the elements included in a device in accordance with the embodiment of FIG. 2;

FIG. 5 is a schematic diagram of the transmitter components for the device shown in FIG. 4; and

FIG. 6 is a diagram of a low cost transmitter for use with the devices of the system of the present invention;

FIG. 7 is plan view of a portion of a public use area, such as a retail merchant shopping complex and showing an alternate embodiment of a locator system in accordance with the invention; and;

FIG. 8 is perspective view of an RF telephony device including a transmitter in accordance with the present invention.

### DETAILED DESCRIPTION

In the description which follows like elements are marked throughout the specification and drawing with the same reference numerals, respectively. Certain components of the system and devices thereof are shown in somewhat generalized or schematic form in the interest of clarity and conciseness.

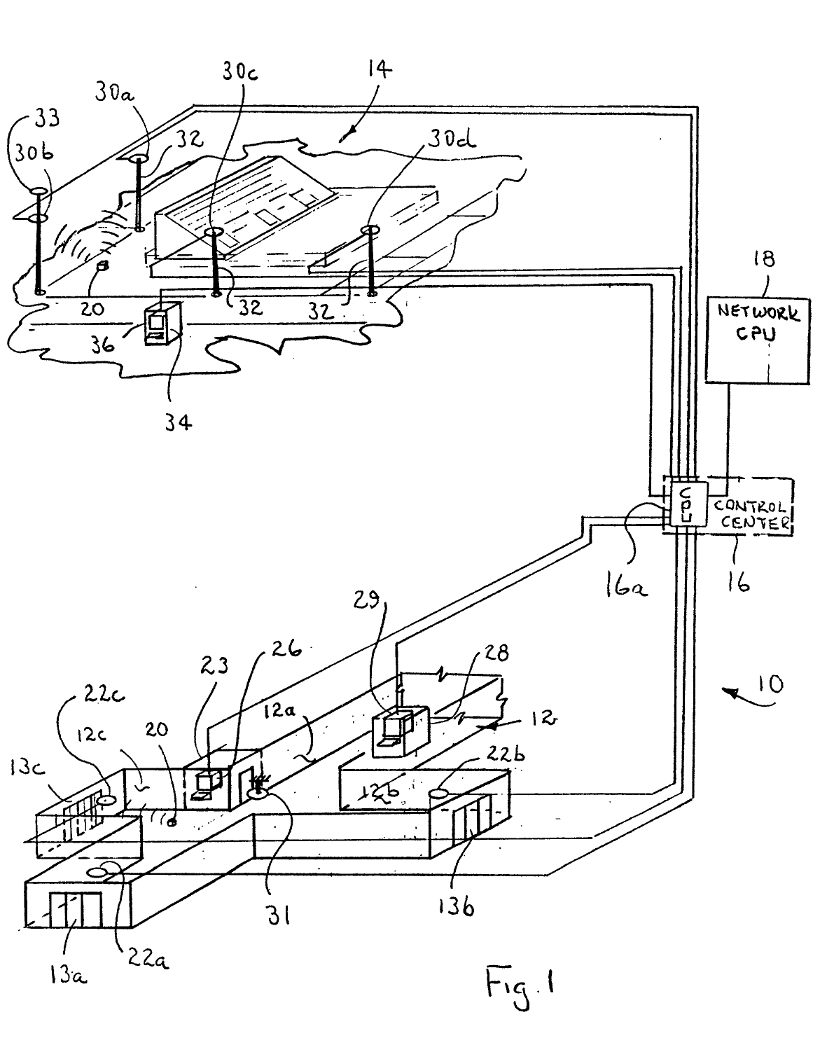

Referring to FIG. 1, there is illustrated, in somewhat schematic form, an embodiment of the wireless location system of the invention being implemented in two different facilities. Those skilled in the art will recognize that the system may comprise stand-alone embodiments for each facility and that the type of facility may vary considerably. By way of example, FIG. 1 illustrates the wireless location system of the present invention, generally designated by the numeral 10, being implemented in a public area or facility such as a retail merchant complex or so-called “shopping mall” 12. FIG. 1 also illustrates an outdoor facility generally available to the public which might comprise, for example, a sports or other entertainment complex 14. In the illustrated embodiment, the system 10 includes a common control center 16 for both the shopping mall 12 and the entertainment complex 14, and including an electronic digital computer or so called central processing unit (CPU) 16a. The control center 16, including its CPU may be characterized by a processor unit based on a PENTIUM® type processor, for example. The control center 16 may also be connected to a master network central processing unit (CPU) 18 which may include memory or storage circuits for additional data to be described further herein. As mentioned above, those skilled in the art will recognize that each of the facilities 12 and 14 may include a control center 16 that is connected to the other system components to provide separate stand-alone systems. However, for the sake of discussion herein the control center 16 may be located off-site from either of the facilities 12 and 14 and operate as a common control center for the facilities.

The present invention contemplates the provision of many small, low power, RF transmitters, two of which are shown in FIG. 1, each indicated by numeral 20. Further details of the transmitters 20 will be set forth hereinbelow. The transmitters 20 are adapted to be carried inconspicuously by a person or persons who either rent or purchase the transmitters and subscribe to a service which operates the system 10.

In regard to the facility 12, it is indicated, by way of example, that the facility comprises a building including intersecting interior corridors 12a, 12b, and 12c, each of which has exterior doors or portals opening thereinto and designated by the numerals 13a, 13b, and 13c. In close proximity to each of the exterior doors 13a, 13b, and 13c are disposed radio frequency (RF) signal receivers 22a, 22b, and 22c, respectively. The receivers 22a, 22b, 22c may be suitably mounted for transmission of RF signals thereto by a person carrying a transmitter 20 as the person approaches one of the doors 13a, 13b and 13c, respectively. Further discussion herein with regard to the receivers 22a, 22b, and 22c may be indicated by the numeral 22 only. The reference numerals 22a, 22b, and 22c are for purposes of discussing the operation of the system in conjunction with the facility 12, by way of example.

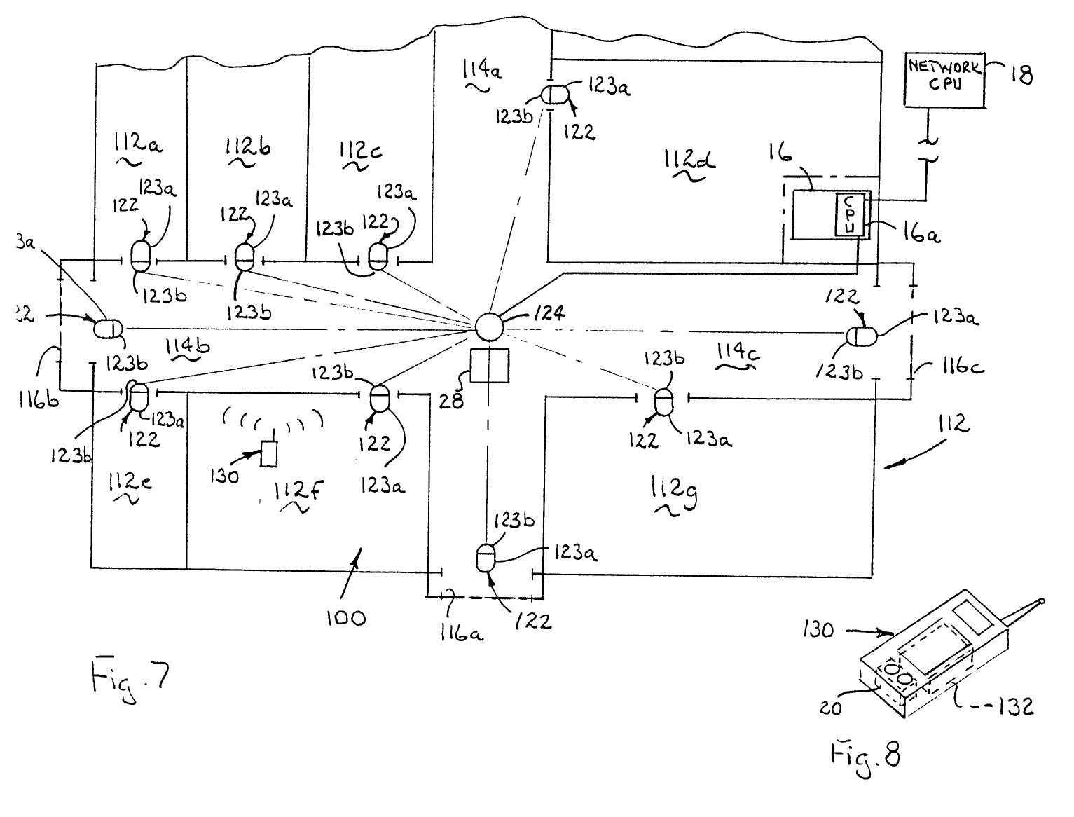

In the system 10 illustrated in FIG. 1 the receivers 22 are shown in proximity to entrance or exit-portals with respect to the facility 12. Those skilled in the art will understand that the receivers 22 may be placed in a predetermined grid pattern throughout a facility which is providing a service in accordance with the system of the invention. Alternatively, receivers may be located in a predetermined arrangement at entrances to respective predetermined spaces within a facility, as will be described in further detail herein in conjunction with the embodiment of FIGS. 7 and 8. Still further, those skilled in the art will appreciate that the number of receivers 22, for example, will be placed in a pattern in sufficient proximity to each other that a transmitter device moving through a facility, such as the facility 12, will always be within range to transmit signals to at least one and preferably two or three receivers at any time. In other words, the receiving range or “footprint” of each receiver 22, for example, will overlap the range or footprint of at least one other receiver and preferably two receivers.

As further shown in FIG. 1, the shopping mall facility 12 includes a security department located in a room 23 forming part of the facility and having therein a digital processor unit 26 including a conventional video monitor, processor circuitry and a keyboard for accessing information associated with the system 10 by authorized personnel of the security department. As further shown in FIG. 1, in conjunction with the mall facility 12, a kiosk 28 is disposed in corridor 12a and is also provided with a digital processor unit 29 which may have a conventional video monitor and a suitable keyboard or keypad which may be accessed by persons using the facility 12 and authorized by the system 10 to access information as to the whereabouts of certain ones of the transmitters 20 being carried by a person or persons for whom the authorized individual or subscriber wishes to know the whereabouts. The kiosk 28 may comprise or be part of a public information booth or directory for the facility 12, for example. Moreover, the kiosk 28 may also include a suitable telecommunications device for voice communication with persons operating the security department 23 or the control center 16, for example.

As indicated in FIG. 1, each of the receivers 22a, 22b, and 22c may be in communication with the control center 16 via conventional communications cables, as shown. In like manner the control center 16 may also be in communication with the processors 26 and 29 by way of conventional communication cables. Alternatively, radio frequency or other forms of communication may be provided between the receivers 22 and certain relay receivers or so called repeater units, not shown in FIG. 1. These relay or repeater units may be hard wired to the control center 16. The control center 16 may be suitably connected to the processor units 26 and 29.

As further indicated in FIG. 1, the system 10 may be implemented in a facility 14 wherein a plurality of RF receivers 30a, 30b, 30c, and 30d may be disposed on suitable towers 32 spaced apart about the facility. The towers 32 may be used for other purposes, such as supporting facility lighting or the like. Accordingly, a person carrying a transmitter 20 at the facility 14 may also send RF signals to one or more of the receivers 30 at the same time. For example, the transmitter 20 shown in FIG. 1 at the facility 14 may send signals of varying intensity or strength simultaneously to the receivers 30a and 30b, such signal strengths being dependent on the distance of the transmitter from each of the receivers. The schematic diagram of FIG. 1 also indicates that the facility 14 may have a kiosk or station 34 at which a processor unit 36, similar to the processor unit 29, is disposed for use by persons authorized to determine the whereabouts of persons carrying selected ones of transmitters 20.

Accordingly, the implementation of the system 10 in accordance with the present invention contemplates that persons desiring to determine the whereabouts of other persons while present in a facility such as a shopping mall or complex 12 or an outdoor complex or facility 14 may subscribe to a service which operates the system 10 and either lease or purchase one or more of transmitters 20. Each of the transmitters 20 is programmed with a specific identifier or code which is included in the RF signal broadcast by the transmitter. The subscriber person is also aware of this code or a related identifier and may, accordingly, make inquiries of the security personnel at the security department 23 if it is desired to determine the whereabouts of a person carrying a transmitter in the facility 12. Alternatively, the authorized subscriber may visit the kiosk 28, input the appropriate identification number or code into the processor unit 29 and receive information displayed on a video monitor portion of the unit 29 indicating the whereabouts of the transmitter 20 for which they are inquiring. Still further, for example, if the system 10 is implemented for use by persons wishing to keep track of children or elderly is persons who are likely to wander away from a designated area, signals generated by at least selected ones of the transmitters 20 may, upon approaching one of the receivers 22a, 22b, or 22c, for example indicate that a person carrying such a transmitter is about to leave the facility. Security personnel are then alerted to the location of that person and the imminent action which such person may be about to take and-which is unwanted by the person subscribing to the system 10.

Still further, as discussed hereinbelow, the transmitters 20 may be used to purposely alert security department personnel by transmitting an additional RF signal from one of the transmitters 20 to the nearest receiver. In other words, a person carrying a transmitter 20 may purposely communicate an emergency signal to security personnel or others monitoring the system 10. Moreover, a subscriber to the system 10 may, when at the facility 12 or 14, utilize the processor units 29 or 36 to communicate a signal via the system 10 to a particular transmitter 20 to cause an audible tone or mechanical vibration-type signal to indicate to the person carrying the transmitter that they should, for example, return to a designated location within the facility, prearranged by the subscriber and the person carrying the transmitter. In this last mentioned instance, the two-way communication is provided by the system 10 wherein transmitters 20 are adapted to receive RF signals and the receivers 22 and 30 are adapted to transmit RF signals.

Accordingly, the transmitters 20 are contemplated as being inexpensive, RF transmitters that are either a self-contained unit or can be readily integrated into other communications devices such as electronic pager devices or so-called cellular telephone devices. For example, in a personal security application, each subscriber to the system 10 would carry a transmitter 20 incorporated in a suitable device on his or her person and the transmitter would substantially continuously transmit a signal including a code which uniquely represents the transmitter and the person carrying the transmitter. The transmitted signal will, of course, have sufficient RF energy to be received by one or more receivers in the facility at which the system is being utilized and which receivers are placed at strategic locations throughout the facility, such as adjacent the portals formed by exterior doors 13a, 13b, and 13c of the facility 12. In other facilities such as the entertainment or exhibit complex 14 the receivers 30a, 30b, 30c, and 30d may be located in a particular grid or pattern, for example, throughout the grounds of the complex so that the location of a person in proximity to one of the receivers may be determined.

The invention contemplates that the receivers 22 or 30 will receive signals from transmitters 20, record a unique serial number or code being transmitted by each transmitter and which is different for each transmitter, classify a message type, measure the signal strength of the signal being transmitted and, possibly measure a bearing or azimuth for the signal with respect to a reference to determine a so-called angle of arrival of the signal. Still further, the time of arrival of the signal from a particular transmitter may also be included in the information received and transmitted by each of the receivers to the control center 16.

The information provided by one or more of the receivers 22 and 30, for example, is communicated to the control center 16 and is used by the CPU 16a to estimate the location of the transmitter in question. The control center CPU 16a is operable to correlate the particular transmitter serial number or identifying code through a suitable connection with the network CPU 18 which includes a database that identifies the subscriber of the transmitter or transmitters in question. The name of the subscriber and the location data for a particular transmitter in question is then also made available to the security department 23 for the facility 12, for example, and may also be available at the processor unit 29 at the kiosk 28 for access by a subscriber or other person who has been granted access to the system by a suitable access code. Kiosks 28 and 34 and associated processor units may be disposed at several locations throughout the facilities 12 and 14, respectively.

Referring now to FIG. 2, there is illustrated a device 20a which may incorporate a transmitter therein and comprise, as shown, a key ring or key chain fob connected to a key ring 20c, for example. The device 20a may have, as indicated, suitable push button switches 40 and 42 thereon as well as visual indicators 44 and 46 indicating the status of the transmitter. For example, the visual indicator 44 may indicate that the transmitter is operable and sufficient power is available to continue transmission. The indicator 46 may indicate a fault in the transmitter or low battery power. The switches 40 and 42 may be used to transmit specialized signals by the person carrying the device 20a. Accordingly, a person carrying the device 20a is continuously transmitting basic so-called locate signals to the system 10 as long as the transmitter, in question, is within range of one of the receivers described above in conjunction with FIG. 1. However, the device 20a may be used by a person seeking assistance or wishing to transmit a particular type of signal by actuating one of the switches 40 or 42 wherein, for example, if the switch 40 is actuated an emergency locate signal is transmitted by a transmitter 20 carried by the device 20a. In this way, a person carrying the device 20a may notify authorities within the facilities 12 or 14, for example, that a personal security or medical emergency has occurred.

In a preferred embodiment of the system 10, the receivers 22 and 30 may be capable of indicating to the control center 16 the signal strength of a transmitter which is within a known distance from one or more receivers and thus be capable of indicating the battery output power as an indication of remaining battery life. In this way, a person carrying a transmitter configured as described below may be alerted to the fact that it may cease operating shortly, or a person monitoring the whereabouts of a particular transmitter may also be alerted as to the situation where a particular transmitter may cease transmitting a useable signal in the near future.

Still further, the transmitter 20 may be provided with an independent radio frequency receiver that effectively allows the system 10 to send messages to a device, such as the device 20a and, upon receipt of an appropriate message, the switch 42 may be actuated to signal a response to the signal received for detection by the subscriber or other party initially sending the signal. This type of device may also be typically used by children or other subscribers whose caretakers, for example, parents, friends, or associates, wish to notify the person carrying the device 20a that they are being sought.

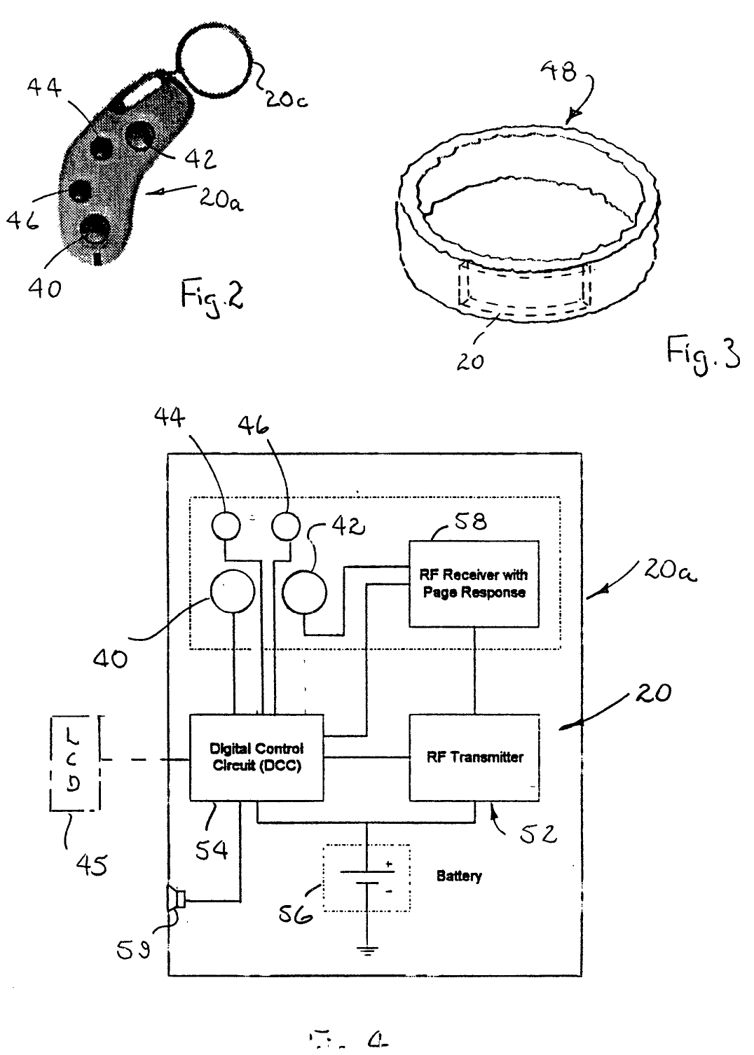

Referring now to FIG. 3, there is illustrated a device 48 in accordance with the invention which comprises a flexible elastic fabric wrist or leg band in which a transmitter 20 is encapsulated or otherwise secured thereto. The device 48 may be inconspicuously worn by a person using the system 10 whose whereabouts is to be monitored by the system when at the facility 12 or the facility 14, for example.

Accordingly, it is contemplated that each transmitter 20 contains a unique serial number or identifier code and may be capable of transmitting a message, including such code, to any of the receivers described above for purposes of locating, approximately, the position of the transmitter, and also, if desired, provide the capability of transmitting an emergency locate signal. The RF transmissions from the transmitters 20 may be brief, for example, ten milliseconds and a repetition rate which is relatively long, for example, once every ten seconds to create a low duty cycle and extend power supply (battery) life. Transmissions from each transmitter 20 can be programmed to occur at random intervals to minimize the chance of interference with other transmissions occurring in the same general location. The message duty cycle should, for example, be increased to about once every second for emergency locate messages to increase the accuracy and refresh rate of the transmitter location estimated by the system 10. The transmitters 20, preferably, are configured such that once an emergency locate mode has been activated they remain in that mode until retrieved from the user or until the batteries expire.

Referring now to FIG. 4, in order to minimize cost and size, each stand-alone transmitter 20 included in a device, such as a device 20a or 48, includes a radio frequency transmitter circuit 52, a digital control circuit 54 and a suitable battery 56. The device 20a may also include a so-called help switch or emergency locate switch 40, and a radio frequency receiver unit 58 including a page response switch 42. A paging signal generator 59 may also be included in the device 20a. The device 20a preferably will transmit RF energy at relatively low effective radiated power, typically about 0.1 milliwatts (−10 dBm) to extend battery life and to minimize cost, size, and heat generation. Such operation will also assure that the device operates below regulatory radiation hazard levels. Preferably, the device 20a or 48 is always “on” and continuously transmitting. The devices 20a and 48 are, preferably, not serviceable and will be packaged as such. Each device 20a or 48 has a unique serial number or code that is assigned to it at manufacture and, thus, when it is sold or rented to a subscriber, a serial number or code is used to correlate the individual device with the subscriber through the database maintained by the network CPU 18. It may-be desirable for the manufacturer, distributor, seller, or subscriber to store the device 20a or 48 in an RF shielded enclosure to minimize cumulative RF signals at the location of manufacture, and at the point of distribution or sale so as to not overload the associated system and to alleviate the possibility, by the subscriber, that an unwanted third party may be tracking their location outside of the network or system facility.

The circuitry of the device 20a shown in FIG. 4 preferably includes in the transmitter circuit 52 means to modulate an input intermediate frequency data signal onto a radio frequency carrier signal. The transmitter circuit 52 then attenuates, amplifies and/or filters the resulting RF signal to meet output power and spectral emission requirements. The digital control circuit 54 controls all aspects of the RF transmitter circuit operation for detection by the system receivers.

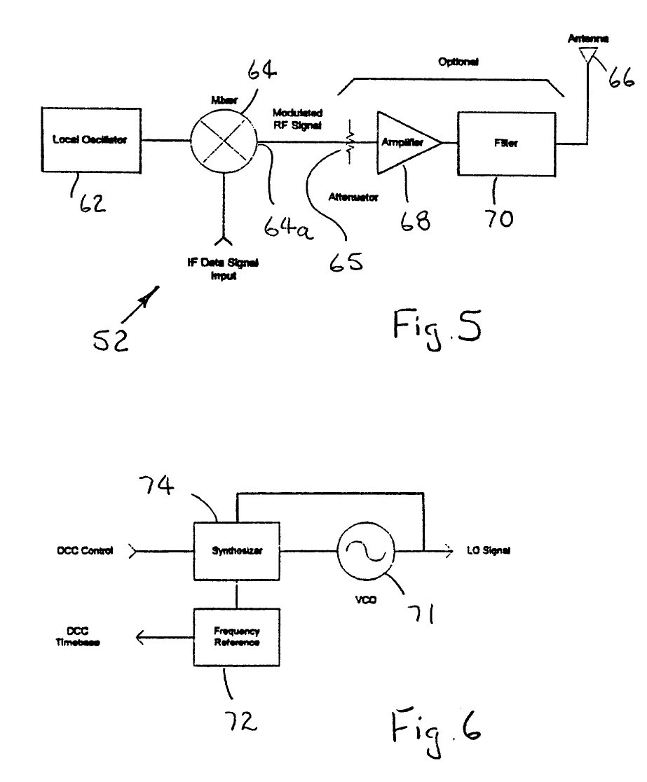

The transmitter circuit 52 may be provided in different forms. An example and a preferred configuration is in accordance with the schematic diagram of FIG. 5. As shown in FIG. 5, a low current local oscillator 62 may provide a signal which is combined with an intermediate frequency (IF) data signal from digital control circuit 54, not shown in FIG. 5, to a mixer 64 to create a modulated RF signal at a mixer output port 64a. This signal, whose center frequency is the same as the output signal of the local oscillator 62 may be subsequently attenuated, amplified, and/or filtered before being fed to a miniaturized antenna 66 by way of, for example, an attenuator 65, an amplifier 68 and filter 70, if used. The resulting radiated signal is of relatively low effective radiated power, as mentioned above, and is sufficient for detection by receivers within an estimated twenty thousand (20,000 square feet ft.²) of an indoor area such as the indoor complex or “mall” 12. The resulting center frequency and spectral emissions of a radiated signal as described above should, of course, meet relevant regulations established by responsible governing authorities, for example, the Federal Communications Commission of the United States of America.

Referring now to FIG. 6, the appropriate local oscillator output signal (the LO signal) can be generated in different ways. One preferred architecture for generating the local oscillator signal that meets the requirements of a device for the system 10 may use conventional components well known to those of ordinary skill in the art, such as a voltage controlled oscillator 71 comprising a single transistor, a varactor, a variety of inductors, capacitors, and/or resistors. Such components are readily commercially available in miniaturized packages or in so-called microchip form. The resulting voltage controlled oscillator output signal is used as the primary signal source for the transmitter 20 creating a carrier signal centered at the desired frequency of operation. Referring to FIG. 6, the voltage controlled oscillator output signal is preferably phase locked to a frequency reference circuit 72 through a synthesizer 74 and which may, typically, operate at a frequency of about 5 MHz to about 30 MHz. The provision of frequency accuracy, minimizing frequency drift over temperature and time, and minimization of size and reduced cost are the primary motivations for providing the type of circuitry described in conjunction with FIGS. 5 and 6. Since the devices 20a and 48 are designed to be operated in temperature controlled environments, for example, on or near a person's body, and therefore be exposed to a temperature range of about 0° C. to 50° C., it is possible to realize the frequency reference desired using a single temperature compensated crystal and an associated variable trim capacitor that can adjust for frequency inaccuracies during manufacture.

As shown in FIG. 6, the frequency reference signal generated by the circuit 72 is fed to synthesizer 74 together with a low power sample of the voltage controlled oscillator signal. The synthesizer 74 locks a sub-harmonic of the voltage controlled oscillator signal to the frequency reference by adjusting the voltage control input of the voltage controlled oscillator 71, thus creating the output signal desired with the same accuracy and stability as the frequency reference.

The digital control circuit 54, shown in FIG. 4 as part of the device 20a, for example, will have a unique serial number or code stored within the circuit for later transmission to the RF receivers 22 or 30 of system 10. The circuit 54 also creates the intermediate frequency (IF) data signal for input to the transmitter circuit 52. This data signal will include the device's serial number or code, the class of signal transmission as well as system control data that allows the RF receivers to lock onto, decode, and error check transmitted signals.

The circuit 54 also maintains system timing using the frequency reference described for the transmitter circuit 52 as a basis for time. In particular, the circuit 54 will activate or “wake up” the transmitter circuit 52, determine the length of transmission, shut off the transmitter circuit 52 and then place the operation of the device 20a in a so-called “sleep” mode until the next scheduled transmission. Transmitter circuit power is also controlled by the circuit 54.

Still further, the circuit 54 may be operable to provide interface to activation of the switch 40 wherein any sequence of switch activations may be decoded by the circuit 54 and then the circuit 54 will provide an appropriate command signal. For example, possible user actuations of the switch are as follows. A so-called standard “push” signal with a duration of about 0.25 seconds to 3.0 seconds will cause the device 20a to send a test locate RF message and emit an audible tone via generator 59, and/or display an “active” state on the indicators 44 or 46 or on a suitable digital display 45, if used. Alternatively, a relatively long activation of the switch 40 of a duration greater than 3.0 seconds, for example, will cause the control circuit 54 to send an appropriate emergency locate message. As indicated earlier, the circuit 54 may also estimate and indicate remaining battery life and capacity on one of the indicators 44 or 46 or on the digital display 45.

Referring further to FIG. 4, the battery 56 is adapted to provide all power for the transmitter circuit 52, the digital control circuit 54 and the components connected thereto. Normally, the battery 56 is not replaceable since the device 20a or 48 is not designed to be serviceable.

The embodiments of the device which include the transmitter 20 in accordance with the present invention and which, by way of example, are shown in FIGS. 2 and 3, are attractive for subscriber usage. However, other forms of packaging of the transmitter 20 may be provided. The device 20a may include, as illustrated, the receiver 58 to provide a way for the system 10 to send messages to device 20a. Accordingly, the receiver 58 is capable of tuning and locking onto an appropriate RF signal being sent by a transmitter portion of the receivers 22 or 30, for example, or some other base station transmitter, such as by transmitters 31 or 33, FIG. 1, suitably connected to control center 16. Upon receipt of an appropriate message for the device 20a the receiver 58 will initiate a so-called page response sequence intended to alert the subscriber of an incoming paging message, for example. This may include emission of an audible sound or a vibration to obtain the device user's attention. After acknowledgment by the user of the device 20a (through a sequence of actuations of the button switch 42, for example) the device may indicate or display a delivered message on the optional display 45. Moreover, the ability of the device 20a to decode incoming messages will be a direct function of the radio frequency coverage footprint of the aforementioned base station transmitters 31 and 33 or the coverage footprint of transmitters disposed in the receivers 22 or 30. The receiver 58 may take one of several forms utilizing existing communications devices. The device 20a, including the receiver 58, and the associated display 45, indicators 44 and 46 and generator 59 will require greater battery capacity than a device such as one which only includes the transmitter circuit 52 and the digital control circuit 54 comprising a basic location determining transmitter for the system 10.

A preferred RF message data structure for the transmitters 20 is one which is short in order to minimize the battery power requirements, as previously mentioned. A preferred data structure also assumes that the receivers 22 and 30 use a very fast automatic gain control circuit or equivalent that can sense and “lock onto” a new signal within about 5.0 milliseconds, for example. A preferred form of data structure may include sixty-four bits of bit synchronization, sixteen bits of word synchronization, thirty-six bits of unique serial number or identification code, four bits of message type (for example, locate message or emergency locate message) and eight bits for error detection by the receivers 22 or 30.

The message modulation may be either narrow band or spread spectrum. Narrow band modulation is the simplest for receiver implementation, uses the least amount of frequency spectrum (when frequency hopping is not used, for example, in 900 MHz unlicensed applications and where transmitted effective radiated power is no greater than approximately 0.1 milliwatts) and the transmitted narrow band signals show extreme receive signal strength variations that are highly dependent on the exact location of the device relative to the receiver and the amount of frequency clutter caused by objects between the two devices. Multipath fading environments are very real and can lead to degraded accuracy and location estimates by the system 10 if not properly accounted for. Angle of arrival measurements are feasible with narrow band RF signals and allow the system to estimate a device or transmitter location using well established algorithms.

Conversely, spread spectrum modulation is advantageous in that appropriate design of the receivers 22 or 30 can provide for using RF message multi-path fading. Spread spectrum modulation also provides for immunity to competing signals which is primarily proportional to the length of the spreading code chosen with more immunity being gained by longer spreading codes. Still further, spread spectrum modulation provides a signal with greater bandwidth and may, in certain unlicensed radio frequency bands (for example, 902-928 MHz ISM band) allow transmission of effective radiated power to increase to 1.0 watts, thereby potentially increasing the footprint coverage of the transmitters of the system 10. However, spread spectrum modulation is potentially more vulnerable to errors in receiver detection but time of arrival measurements are easier to obtain on spread spectrum RF signals to thereby allow this system to more accurately estimate transmitter location using established time difference of arrival algorithms. Any number of well established RF modulations may be chosen that optimize system cost, bandwidth utilization, and immunity to frequency variation. These include BPSK, FSK, GMSK, and DPSK among others.

An example of direct sequence spread spectrum modulation for transmissions by the devices 20a or 48 that optimizes cost, receive signal strength accuracy, immunity to jamming signals and also provides for time difference of arrival estimation includes use of a Walsh type code with a code length of sixty-four chips, a chipping rate of seven hundred fifty-five KCPS, a bit length of eighty-five microseconds, sixty-four orthogonal codes and BPSK modulation with bandwidth (null to null) of 1.510 MHz.

Operating frequencies for the transmitters 20 may be within the licensed spectrum to allow exclusive use of specific frequencies in specific geographic regions as dictated by a government authority. For distances of less than about one mile the unlicensed spectrum is effective. However, the unlicensed spectrum may be required to be shared by multiple independent users and therefore a system such as the system 10 must incorporate very short distances between transmitters and receivers or utilize other methods of interference rejection to maintain a reliable wireless connection.

As mentioned previously, the system 10 may be adapted to operate in the 902-928 MHz ISM unlicensed band using the above referenced sequence spread spectrum modulation. Such a system allows ample bandwidth for selection of the transmitter RF signal center frequency, and enables transmission at an effective radiated power greater than 0.1 milliwatts, if needed. Use of a sixty-four chip spreading code provides some measure of interference rejection against other users in the band. Since most applications of the system 10 are intended for use in a controlled environment, such as the mall or complex 12 or 14, the operators of the system 10 may also restrict deployment of other systems that may potentially cause interference.

The receivers 22 and 30 may be appropriately designed and provided with aesthetically pleasing housings or covers so as not to attract attention from a casual observer, particularly within indoor environments. Indoor receivers such as the receivers 22, have relaxed environmental requirements and thereby will have minimum cost to the system. On the other hand receivers, such as the receivers 30, when located outdoors will have greater environmental design criteria. Either receiver may operate using DC or AC power sources, whichever are more convenient, taking into account the availability of such at the facility using the system 10.

The receivers 22 and 30 may use wide bandwidth spread spectrum modulation of the transmitted signal, and use multiple signals as a function of time to allow averaging of the signal samples. Moreover, two or more independent receiver circuits within the same receiver unit or assembly may be provided to allow averaging of the signal measured by antennas separated from each other.

Referring now to FIGS. 7 and 8, an alternate embodiment of a locator system in accordance with the invention is illustrated and generally designated by the numeral 100. The system 100 is located in a public use facility, such as a retail merchant shopping complex or mall 112 similar to the facility 12 illustrated in FIG. 1. The facility 112 includes intersecting interior corridors 114a, 114b and 114c. The corridors 114a, 114b and 114c are in communication with entrance and exit portals 116a, 116b and 116c, respectively. A system kiosk 28 is shown located at the intersection of the corridors 114a, 114b and 114c for access by persons utilizing the service provided by the system 100. The facility 112 is shown divided into interior spaces 112a through 112g, for example, each having an entry (also serving as an exit) into the space from a corridor, as shown. Receiver-transmitter units 122 similar in some respects to the receivers 22, are located at the entries to each of the spaces 112a through 112g as well as adjacent to each of the facility entry and exit portals 116a through 116c, as illustrated. Each of the receiver-transmitter units 122 includes an RF receiver 123a and a transmitter 123b, as shown, which is within a line of sight of a receiver and signal relay or “repeater” unit 124 centrally located at the intersection of the corridors 114a, 114b and 114c. The transmitters 123b may be RF type transmitters or, preferably, IR type transmitters. The receiver unit 124 will, of course, be compatible with the type of signal transmission capability of the receiver-transmitter units 122. One advantage of the system 112, as illustrated, with receivers 123a located at entries to enclosed spaces 112a through 112g, for example, is that the receiver-transmitter units 122 will be easily installed without requiring hard wiring of the units to the control center 16. By providing the receiver-transmitter units 122 with IR or RF transmitter portions 123b which transmit to the receiver unit 124, the only hard wiring of the facility 112 required is between the receiver and relay unit 124 to the control center 16. In the embodiment of FIG. 7 the control center 16 is located within the facility 112, although this is not required.

FIGS. 7 and 8 illustrate a transmitter device in accordance with the invention incorporated in an RF telephony device or so called cellular telephone, generally designated by the numeral 130. When a transmitter device, such as the device 130, is located in a space, such as the interior space 112f, FIG. 7, it is within range of at least two receiver-transmitter units 122, that is, the receiver 123a at the entry to the space 112e and the receiver 123a at the entry to the space 112f, for example. Signals received at the receiver-transmitter units 122 at the entries to the spaces 112e and 112f, transmit the received signal to the receiver unit 124 and to the control center 16 wherein times of arrival of the signals to the respective units may be utilized to calculate the location of the device 130. Alternatively, if the facility 112 is constructed of certain materials or is arranged in such a way as to prevent coherent RF transmission through the wall structures dividing the spaces 112a through 112g the receiver-transmitter unit 122 at the entry to the space 112f will, at least, be capable of signaling that a person carrying the device 130 is within the space 112f.

Referring briefly to FIG. 8, the device 130, as previously described, may comprise an RF telephony device or so called cellular telephone having a transmitter 20 disposed therein and suitably configured to utilize either its own battery or the battery for the telephony device. The transmitter 20 may, in a manner similar to the device shown in FIG. 4, include the RF receiver with page response circuit 58, the control switches 40 and 42 and the indicators 44 and 46. The telephony device 130 will, of course, include its own RF transmitter/receiver unit 132 incorporated therein.

The operation of the system 100 is substantially the same as the system 10 with the advantage that installation of the system in an existing facility is less complicated when the system receivers incorporate transmitter devices which are capable of line of sight transmission to a receiver or a relay unit such as the unit 124. Of course, if the facility permits, as a consequence of its structural features, the transmitter portions 123b may be RF transmitters and the receiver-transmitter units 122 may be located in other patterns within each of the spaces 112a through 112g, for example.

Another advantage of the systems 10 and 100 is that with these systems installed in a large number of public facilities or public use areas, persons subscribing to the service provided by the systems may utilize the system at each such facility. Still further, a service utilizing a system, such as the system 100, in particular, may, with each subscriber's permission, use transmitter locator signals from each of the devices, such as the devices 20a, 48 and 130 to provide tracking of a person carrying the device with respect to their interests and so called shopping habits, since the system 100 will be capable of indicating whenever a device 20a, 48 or 130 enters the facility 112 or any of the spaces 112a through 112g. Such data may be useful to developers and planners of facilities, such as the facility 112, as well as retail merchants occupying the respective spaces 112a through 112g.

Those skilled in the art will appreciate from the foregoing description that a unique wireless locator system has been provided by the present invention. The construction and operation of the system 10 is believed to be in the purview of one of ordinary skill in the art based on the foregoing description. Although a preferred embodiment of a system and preferred embodiments of transmitter devices utilized in the system have been described in detail herein those skilled in the art will also recognize that various substitutions and modifications may be made without departing from the scope and spirit of the appended claims.

What is claimed is:

1. A wireless locator system for determining the approximate location within a predetermined area of a person or article carrying a radio frequency (RF) transmitter, comprising:
at least one low power RF transmitter incorporated in a device for attachment to a person or an article within said predetermined area;
a plurality of RF receivers spaced at predetermined locations within said predetermined area for receiving signals from said RF transmitter and for transmitting signals; and
a control center including a central processing unit for receiving said signals transmitted from said RF receivers and operable to identify at least one of a person authorized to carry said RF transmitter and the approximate location of said RF transmitter within said predetermined area.

2. The system set forth in claim 1 wherein:
said predetermined area is selected from a group consisting of a retail merchant indoor complex, a retail merchant outdoor complex, a public area including an entertainment or amusement complex, an exhibit hall, and a building having multiple corridors and entrance doors.

3. The system set forth in claim 2 wherein:
at least one of said RF receivers is disposed in proximity to each said entrance door, respectively, of said building.

4. The system set forth in claim 2 wherein:
at least one of said RF receivers is spaced apart out of doors within said predetermined area for receiving signals from said transmitter.

5. The system set forth in claim 1 including:
a network processing unit including a database identifying a plurality of subscribers or persons authorized to carry a plurality of said RF transmitters, respectively, said network processing unit being in communication with said control center processing unit.

6. The system set forth in claim 5 including:
at least one processing unit including a visual display disposed in said predetermined area for providing information identifying said RF transmitter and the approximate location of said RF transmitter.

7. The system set forth in claim 6 wherein:
said at least one processing unit disposed in said predetermined area is accessible by persons authorized to use said RF transmitter whereby said persons authorized to use said RF transmitter may determine the location of said RF transmitter within said predetermined area.

8. The system set forth in claim 1 wherein:
said RF transmitter is incorporated in a device which may be carried inconspicuously by a person without encumbering said person's normal physical activities.

9. The system set forth in claim 8 wherein:
said RF transmitter is incorporated in a device comprising a key ring fob.

10. The system set forth in claim 8 wherein:
said RF transmitter is incorporated in a device comprising one of an elastic arm b and and leg band.

11. The system set forth in claim 8 wherein:
said RF transmitter is incorporated in an RF telephony device.

12. The system set forth in claim 1 wherein:
said RF transmitter includes a radio frequency transmitter circuit, a digital control circuit, and a battery for providing electrical power to said transmitter circuit and said control circuit, respectively.

13. The system set forth in claim 12 wherein:
said device includes a device receiver operably connected to said digital control circuit for receiving signals from a person seeking the location of said transmitter and said device receiver includes means for communicating a signal through said transmitter circuit to indicate receipt of a signal by said RF transmitter.

14. The system set forth in claim 1 further comprising:
user operable switch means associated with said device for causing said RF transmitter to transmit an emergency signal to said control center processing unit.

15. The system set forth in claim 1 wherein:
said RF transmitter includes a transmitter circuit, a digital control circuit, and battery means for providing electrical power to said transmitter circuit and said digital control circuit and said transmitter circuit is operable to transmit an RF signal at an effective radiated power of less than about 1.0 watt.

16. The system set forth in claim 15 wherein:
said digital control circuit is operable to cause said transmitter circuit to transmit a code associated with said RF transmitter identifying said RF transmitter to said control center processing unit.

17. The system set forth in claim 15 wherein:
said digital control circuit is operable to cause said transmitter circuit to transmit RF signals at discrete intervals.

18. The system set forth in claim 17 wherein:
said digital control circuit is operably connected to a user actuated switch for receiving signals from said user actuated switch in response to actuation thereof to cause said transmitter circuit to generate at least one of a test signal and an emergency locate signal, respectively.

19. The system set forth in claim 15 wherein:
said transmitter circuit comprises a voltage controlled oscillator operably connected to a mixer, said mixer being operable to receive an intermediate frequency data signal and produce a modulated radio frequency signal to at least one of an attenuator, amplifier and filter for transmission to an antenna.

20. The system set forth in claim 19 wherein:
said oscillator comprises a synthesizer circuit and a frequency reference circuit for producing a signal for use as the primary signal source of said RF transmitter and creating a carrier signal centered at a desired frequency of operation.

21. The system set forth in claim 1 wherein:
said RF transmitter is operable to transmit radio frequency messages having a data structure comprising plural bits for bit synchronization, word synchronization, a transmitter serial number, and a message type, respectively.

22. The system set forth in claim 1 wherein:
said RF transmitter is operable to transmit signals by narrow band modulation.

23. The system set forth in claim 1 wherein:
said RF transmitter is operable to transmit signals by spread spectrum modulation.

24. The system set forth in claim 25 wherein:
said RF transmitter is operable to transmit signals in the range of 902-928 MHz.

25. In a wireless locator system for determining the approximate location of a person or article within a predetermined area, a plurality of radio frequency (RF) receivers spaced at predetermined locations within said predetermined area for receiving RF signals from one or more RF transmitters, a control center including a central processing unit operably connected to said RF receivers for receiving signals from said RF receivers to identify at least one of a person authorized to carry an RF transmitter and the approximate location of said RF transmitter, said one or more RF transmitters each comprising:
a radio frequency transmitter circuit, a digital control circuit operably connected to said transmitter circuit and a battery for providing electrical power to said transmitter circuit and said control circuit, respectively, for causing said transmitter circuit to transmit an RF signal at an effective radiated power of between about 0.1 milliwatts and 1.0 watts, said RF signal including a code associated with said RF transmitter identifying said RF transmitter to said control center processing unit.

26. The system set forth in claim 25 wherein:
at least selected ones of said RF receivers are disposed, respectively, at an entry to an interior space within a building defining said predetermined area.

27. The system set forth in claim 25 wherein:
said RF receivers include, respectively, transmitter portions for transmitting signals to a relay receiver, said relay receiver being in signal transmitting communication with said central processing unit.

28. The system set forth in claim 27 wherein:
said transmitter portions of said receivers and said relay receiver are operable to transmit and receive IR signals.

29. The system set forth in claim 25 wherein:
said predetermined area comprises a retail merchant complex including a building divided into a plurality of interior spaces, each of said spaces having an entry; and
said system includes an RF receiver disposed at selected ones of said entries to said spaces for receiving signals from said at least one transmitter and for transmitting said signal to said control center by way of a relay receiver.

30. The system set forth in claim 25 wherein:
said RF transmitter is operable to transmit radio frequency messages having a data structure comprising plural bits for bit synchronization, word synchronization, a transmitter serial number, and a message type, respectively.

31. The system set forth in claim 25 wherein:
said RF transmitter is operable to transmit signals by narrow band modulation.

32. The system set forth in claim 25 wherein:
said RF transmitter is operable to transmit signals by spread spectrum modulation.

33. The system set forth in claim 25 wherein:
said RF transmitter is operable to transmit signals in the range of about 902-928 MHz.

34. The system set forth in claim 25 wherein:
said RF transmitter is incorporated in a device including user operable switch means associated with said device for causing said transmitter to transmit one of a test signal and an emergency signal to said control center via at least one of said RF receivers.

35. The RF transmitter set forth in claim 25 wherein:
said transmitter circuit includes a voltage controlled oscillator operably connected to a mixer, said mixer being operable to receive an intermediate frequency data signal to produce a modulated radio frequency signal to at least one of an attenuator, amplifier and filter for transmission to an antenna associated with said device.

36. The system set forth in claim 35 wherein:
said oscillator includes a synthesizer circuit and a frequency reference circuit for producing a signal for use as the primary signal source of said RF transmitter and creating a carrier signal centered at a desired frequency of operation.

37. A method for determining the whereabouts of persons within a designated area comprising the steps of:
providing a plurality of low power, compact RF transmitter devices, said devices being capable of being worn or carried by persons without encumbering normal physical activity by said persons, said transmitter devices being operable to transmit RF signals in a predetermined frequency range;
providing said designated area with a plurality of spaced apart RF receivers operable to receive signals from said transmitter devices, respectively, said receivers being operably connected to a control center processing unit for transmitting information related to at least one of transmitter device identification number, signal strength, transmitter device bearing with respect to a reference at said receiver and signal time of arrival to said processing unit;
providing persons with respective ones of said transmitter devices for use in said designated area, said transmitter devices being operable to transmit RF signals to receivers in proximity for receiving said RF signals and for transmitting said information to said control center processing unit; and
determining the location of a person carrying a particular one of said transmitter devices based on said information.

38. The method set forth in claim 37 further comprising the steps of:
providing a processing unit including a visual display at said designated area;
providing authorized persons with an access code for accessing said processing unit at said designated area, said code being associated with a particular one or ones of said transmitter devices; and
entering said access code in said processing unit at said designated area to determine the whereabouts of a selected transmitter device associated with said access code.

39. The method set forth in claim 37 further comprising the steps of:
providing said transmitter devices with RF page receivers; and
transmitting a signal to a selected one of said transmitter devices to provide a communication signal to said person carrying said selected transmitter device.

40. The method set forth in claim 37 wherein:
said designated area comprises a building divided into a plurality of interior spaces and at least one corridor providing access to said interior spaces through entries to said interior spaces, respectively, and said method includes the steps of:
placing an RF receiver at selected ones of said entries, said RF receivers including transmitter portions for transmitting signals related to signals received by said RF receivers;
placing an RF receiver and signal relay unit within said facility for receiving signals transmitted by said transmitter portions of said RF receivers, said receiver relay unit being in signal transmitting communication with said processing unit.
